(19) United States
(12) Patent Application Publication
(10) Pub. No.: US 2021/0354270 A1
(43) Pub. Date: Nov. 18, 2021

(54) TRIGGER CLAMP WITH PINCH PROTECTION

(71) Applicant: Stanley Black & Decker, Inc., New Britain, CT (US)

(72) Inventors: Christopher Cate, Hamden, CT (US); Josue Campos, New Haven, CT (US)

(21) Appl. No.: 15/930,674

(22) Filed: May 13, 2020

(51) Int. Cl. B25B 5/06; B25B 5/16

(52) U.S. Cl. CPC B25B 5/068; B25B 5/16

(57) ABSTRACT

A trigger clamp includes a rail, a movable jaw configured to move along the rail, a handle fixed relative to the movable jaw, and a trigger movable relative to the handle, which when pulled towards the handle causes movement of the movable jaw along the rail. The handle comprises a trigger facing wall generally extending along a first plane, and a fin generally extending to a second plane, the second plane being closer to the trigger than the first plane. The trigger is shaped to be received to an interior of the fin at least when the trigger is squeezed by a hand of a user, such that an index finger of the user remains at the exterior of the fin. Methods of manufacturing and using similar trigger clamps are also disclosed.

### BACKGROUND OF THE INVENTION

### 1. Field of the Invention

This invention relates to trigger clamps that include a squeezable trigger to move a movable jaw member along a rail member such as a pipe or bar, either towards another jaw member (e.g., to clamp a surface therebetween), or away from another jaw member (e.g., to act as a spreader).

### 2. Description of Related Art

Aspects of the present disclosure will be made with reference to the anatomy of a user's hand, which is generically shown in FIGS. 1 and 2. As shown in the exterior view of FIG. 1, a user's hand 100 typically includes a palm 101 to which is connected a thumb 102, a forefinger 104, a middle finger 106, a ring finger 108, and a pinky finger 110. A web 112 of muscles and skin connects the base of the thumb 102 and forefinger 104. In addition, the palm includes two fleshy pads in the form of the thenar eminence 114 on the thumb side of the palm 101 and the hypothenar eminence 116 on the pinky side of the palm 101. Further, there are fleshy pads 118, 120, 122, 124, and 126 on the palm side at the base of the thumb and each finger.

As shown in the skeletal view of FIG. 2, the palm 101 is formed by five metacarpals 128. Each finger is formed by a proximal phalange 130 coupled to a metacarpal 128, thus being proximal to the palm 101 along each finger. An intermediate phalange 132 is coupled to the proximal phalange 130, and is located between the proximal phalange 130 and a distal phalange 134 which is typically coupled to the intermediate phalange 132, and is distal from the palm 101 along its respective finger. The thumb 102 is formed by a proximal phalange 130 coupled to a metacarpal 128, and a distal phalange 134 coupled to the proximal phalange 130 without an associated intermediate phalange 132. There are knuckles at the joints between these bones.

FIGS. 3-5 depict close up views of a conventional trigger clamp 150, showing in detail the handle 160 and trigger 170 of the movable jaw member 180. As shown between FIGS. 3 and 4, trigger 170 pivots or otherwise moves towards the handle 160 to actuate a movement of the movable jaw 180 along a rail member 190. As shown in FIG. 5, it may be appreciated that when a user having an average sized hand 100 is squeezing the trigger 170 towards the handle 160 of such conventional trigger clamps 150, it is possible for the fleshy pad 120 adjacent to the web 112 of the user's hand 100 to wrinkle and protrude such that it becomes positioned between the handle 160 and trigger 170. As such, unless care is taken, the user may inadvertently pinch the fleshy pad 120 between the handle 160 and trigger 170 when the user squeezes the trigger 170 to apply a clamping or spreading force via the trigger clamp 150. Among other improvements, the present disclosure endeavors to address such design characteristics.

### SUMMARY OF EMBODIMENTS OF THE INVENTION

According to an embodiment, A trigger clamp includes a rail, a movable jaw configured to move along the rail, a handle fixed relative to the movable jaw, and a trigger movable relative to the handle, which when pulled towards the handle causes movement of the movable jaw along the rail. The handle comprises a trigger facing wall generally extending along a first plane, and a fin generally extending to a second plane, the second plane being closer to the trigger than the first plane. The trigger is shaped to be received to an interior of the fin at least when the trigger is squeezed by a hand of a user, such that an index finger of the user remains at the exterior of the fin.

According to another embodiment, a method of manufacturing a trigger clamp includes providing a rail, forming a movable jaw configured to move along the rail, with a handle fixed relative to the movable jaw, and providing a trigger movable relative to the handle, which when pulled towards the handle causes movement of the movable jaw along the rail. The handle comprises a trigger facing wall generally extending along a first plane, and a fin generally extending to a second plane, the second plane being closer to the trigger than the first plane. The trigger is shaped to be received to an interior of the fin at least when the trigger is squeezed by a hand of a user, such that an index finger of the user remains at the exterior of the fin.

According to another embodiment, a method of operating a trigger clamp is provided, wherein the trigger clamp comprises a rail, a movable jaw configured to move along the rail, a handle fixed relative to the movable jaw, and a trigger movable relative to the handle, which when pulled towards the handle causes movement of the movable jaw along the rail, wherein the handle comprises a trigger facing wall generally extending along a first plane, and a fin generally extending to a second plane, the second plane being closer to the trigger than the first plane, and wherein the trigger is shaped to be selectively received to an interior of the fin. The method includes engaging, by a hand of a user, the handle and the trigger of the trigger clamp, such that a palm of the user wraps around a backwall of the handle distal from the trigger, and at least an index finger of the user extends over the fin to the trigger. The method also includes pulling the trigger towards the handle with at least the index finger, such that the index finger of the user remains at the exterior of the fin while the trigger is in or moves into an interior of the fin.

These and other aspects of various embodiments of the present invention, as well as the methods of operation and functions of the related elements of structure and the combination of parts and economies of manufacture, will become more apparent upon consideration of the following description with reference to the accompanying drawings, all of which form a part of this specification, wherein like reference numerals designate corresponding parts in the various figures. In one embodiment of the invention, the structural components illustrated herein are drawn to scale. It is to be expressly understood, however, that the drawings are for the purpose of illustration and description only and are not intended as a definition of the limits of the invention, and that other scales and proportions are also contemplated and covered by this application. In addition, it should be appreciated that structural features shown or described in any one embodiment herein can be used in other embodiments as well. As used in the specification, the singular form of “a”, “an”, and “the” include plural referents unless the context clearly dictates otherwise.

### BRIEF DESCRIPTION OF THE DRAWINGS

For a better understanding of embodiments of the present invention as well as other objects and further features thereof, reference is made to the following description which is to be used in conjunction with the accompanying drawings, where:

As noted above, FIG. 1 shows an external view of a human hand from the palm side;

FIG. 2 is a schematic view of the bones of a human hand;

FIG. 3 is an enlarged side view of the movable jaw region of a conventional trigger clamp, with the trigger in an unactuated position away from a handle;

FIG. 4 shows the view of FIG. 3, however with the trigger of the conventional trigger clamp held in an actuated position pulled close to the handle; and

FIG. 5 shows a perspective view of a hand engaging the conventional trigger clamp, showing how the fleshy portion of the user's upper palm curls into a position that may come between the trigger and the handle when squeezing the trigger.

As discussed in greater detail below, FIG. 6 illustrates a left side view of a trigger clamp of the present disclosure with a trigger thereof in an unactuated position away from a handle thereof, where a fin thereof shields an index finger of a user squeezing the trigger;

FIG. 7 illustrates a left side view of the trigger clamp of FIG. 6 with the trigger held in an actuated position pulled close to the handle;

FIG. 8 illustrates a top right perspective view of the trigger clamp of FIG. 6 as engaged by a user's hand prior to squeezing the trigger;

FIG. 9 illustrates a top right perspective view of the trigger clamp of FIG. 6 as engaged by a user's hand while squeezing the trigger;

FIG. 10 illustrates a left side view of the trigger clamp of FIG. 6 as engaged by a user's hand prior to squeezing the trigger;

FIG. 11 illustrates an alternate embodiment of the trigger clamp of FIG. 6, where the fin thereof extends towards a pinkie finger of a user to shield other fingers of the user when squeezing the trigger;

FIG. 12 Illustrates a bottom left perspective view of the trigger clamp of FIG. 6 with the trigger held in an unactuated position away from the handle; and

FIG. 13 illustrates a bottom right perspective view of the trigger clamp of FIG. 6 with the trigger held in an actuated position pulled close to the handle.

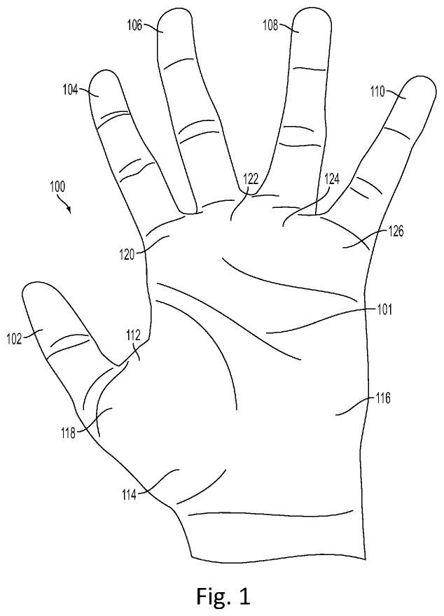

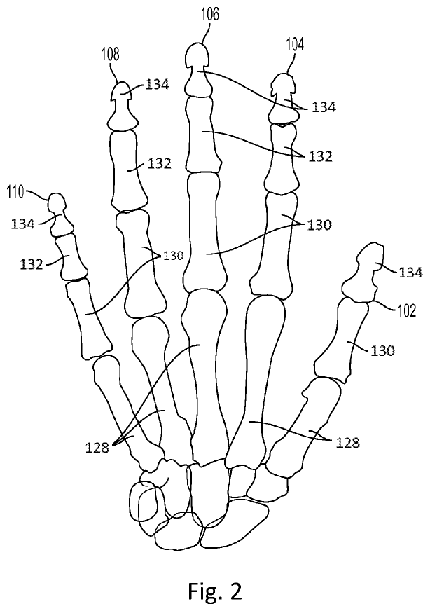

### DETAILED DESCRIPTION OF EXEMPLARY EMBODIMENTS OF THE INVENTION

Turning to FIG. 6, an embodiment of a trigger clamp 200 of the present disclosure is shown. The trigger clamp 200 includes a rail member 210 supporting a fixed jaw 220 having a fixed jaw pad 230 mounted thereon. Also mounted to the rail member 210 is a movable jaw 240 that is configured to move along the rail member 210. The movable jaw 240 includes a movable jaw pad 250. As such, moving the movable jaw 240 along the rail member 210 may cause the movable jaw pad 250 closer to the fixed jaw pad 230, so as to clamp one or more substrates therebetween. In some embodiments, the fixed jaw 220 may be removable (e.g., through a removal mechanism actuated through an actuator 260, so that the fixed jaw 260 may be disengaged from the rail member 210, and, for example, may be repositioned to the opposite end of the rail member 210, such as to an engagement aperture 270. In such a configuration, the fixed jaw pad 230 and the movable jaw pad 250 face away from one another, so that the trigger clamp 200 may be used as a spreader, and movement of the movable jaw 240 relative to the rail member 210 pushes surfaces engaged by the fixed jaw pad 230 and the movable jaw pad 250 away from each other.

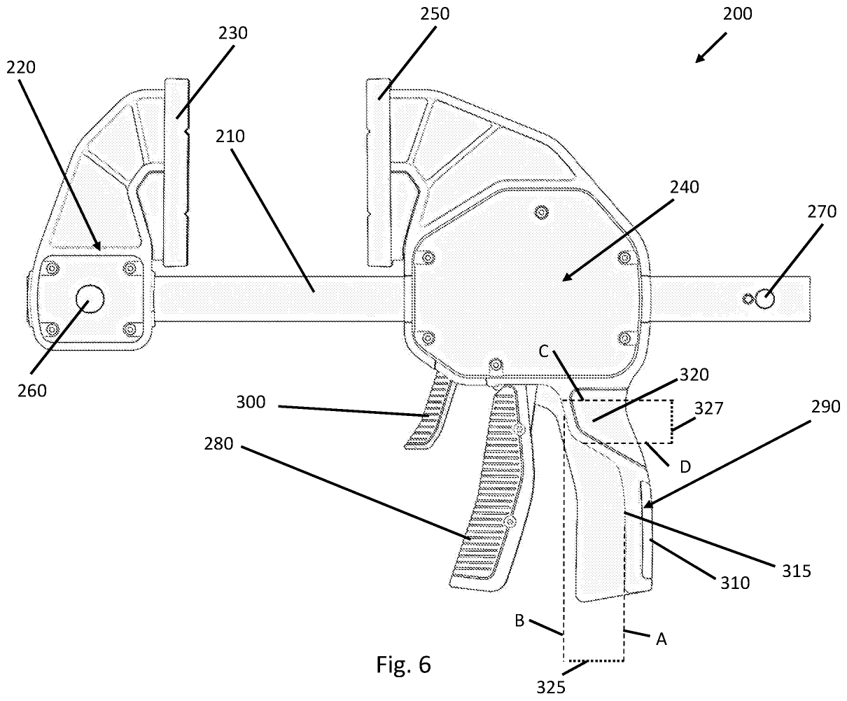

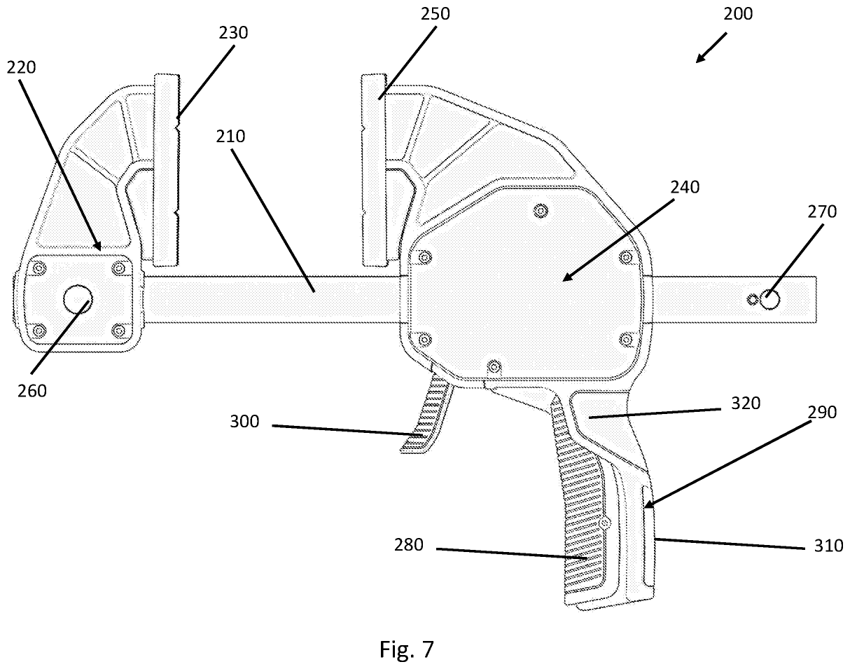

Similar to conventional trigger clamps, movement of the movable jaw 240 along the rail member 210 is actuated by squeezing a trigger 280 towards a handle 290, such as is shown between FIG. 6 and FIG. 7. As with conventional trigger clamps, actuation of the trigger 280 pulls the movable jaw 240 along the rail member 210 by a predefined amount with each squeeze of the trigger 280, so that multiple squeezes of the trigger 280 are utilized to pull the movable jaw pad 250 towards the fixed jaw pad 230 for a clamping operation, or away from the fixed jaw pad 230 for a spreading operation. It may be appreciated that the movement mechanism of the movable jaw 240 is configured to apply additional force with each squeeze of the trigger 280, so that an increased or desired clamping or spreading force is applied. It may be appreciated that in the trigger clamp 200, the trigger 280 and handle 290 may have generally complementary shapes, such that when squeezed the contours of the trigger 280 match the contours of the handle 290, promoting a compactified configuration of the as-squeezed trigger-handle combination giving assurance to a user that a maximal amount of pressure has been applied from a given squeeze of the trigger 280, and that release and re-squeezing of the trigger 280 is needed for application of additional clamping force.

In some embodiments, a secondary release trigger 300 may be provided to disengage the incremental movement action of the movable jaw 240 relative to the rail member 210, so that the movable jaw 240 may freely slide in both directions along the rail member 210 (e.g., towards or away from the fixed jaw 220). Accordingly, the release trigger 300 may be used to disengage the movable jaw 240 from under a clamping force, and may be used to quickly position the movable jaw 240 along the rail member 210 (e.g. relative to the fixed jaw 220), so as to reduce the number of squeezes of the trigger 280 needed to apply the desired clamping force.

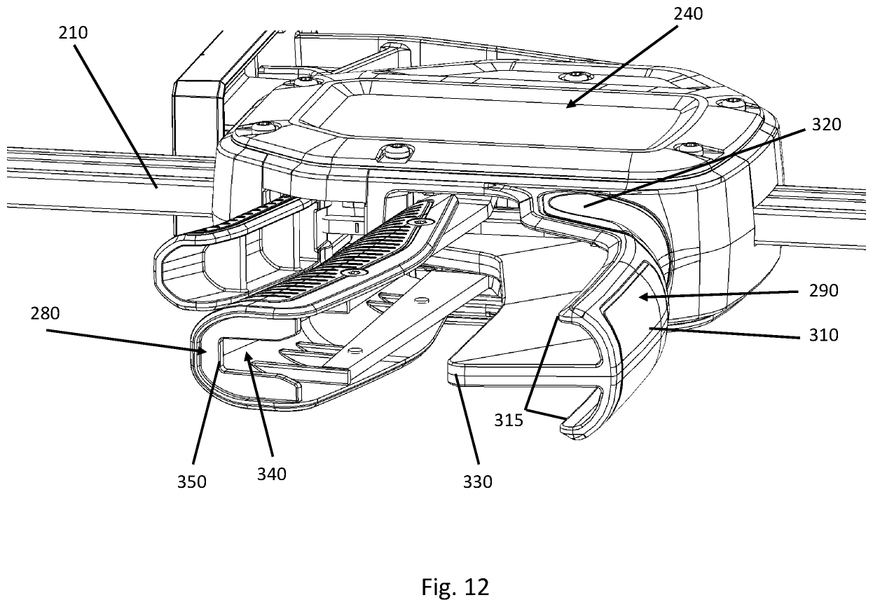

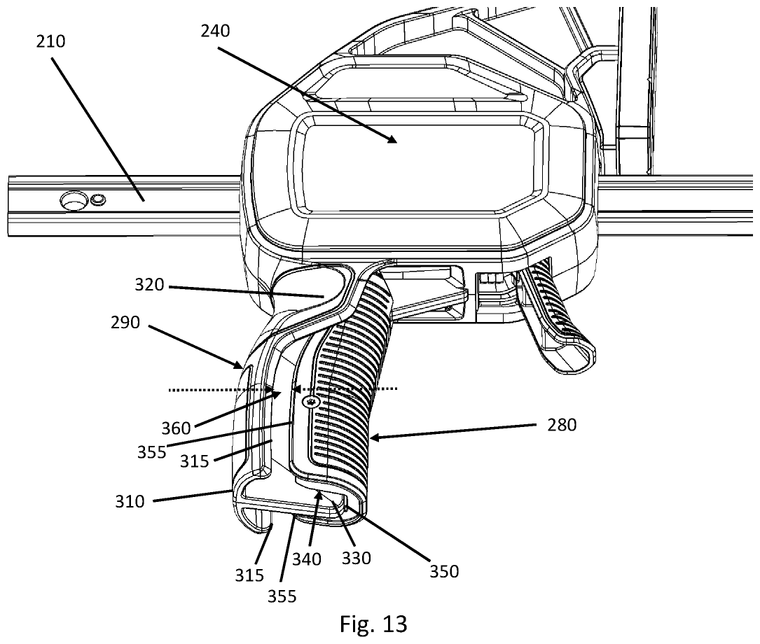

Looking with greater detail at the handle 290 of the trigger clamp 200, it may be appreciated that the handle 290 includes a backwall 310 shaped to engage with the palm 101, such as from the web 112 to the hypothenar eminence 116 thereof, while the fingers extend towards, and at least some extend around, the trigger 280. The backwall 310 may generally include a trigger-facing wall 315, which in some embodiments may protrude (e.g., curve) towards the trigger 280. An example of such a configuration is shown in the illustrated embodiment, including more clearly in FIGS. 12 and 13 discussed in greater detail below.

As shown herein, the trigger facing wall 315 is shaped so that a fin 320 protrudes further from the backwall 310 than the remainder of the trigger facing wall 315 at a point of the handle 290 that is closer to a pivot axis between the trigger 280 and the handle 290 (e.g., adjacent to where the thumb 102 and the index finger 104 extend forward toward the trigger 280). As further described herein, the trigger 280 and the handle 290 may be configured so that a region of the trigger 280 positioned to be engaged by the index finger 104 (e.g., proximal to the rail member 210) is permanently partially positioned underneath the fin 320, or is otherwise shaped so that when the trigger 280 is squeezed, the trigger 280 is received in the handle 290, such that the fin 320 is positioned between the hand 100 and the trigger 280 adjacent to the index finger 104.

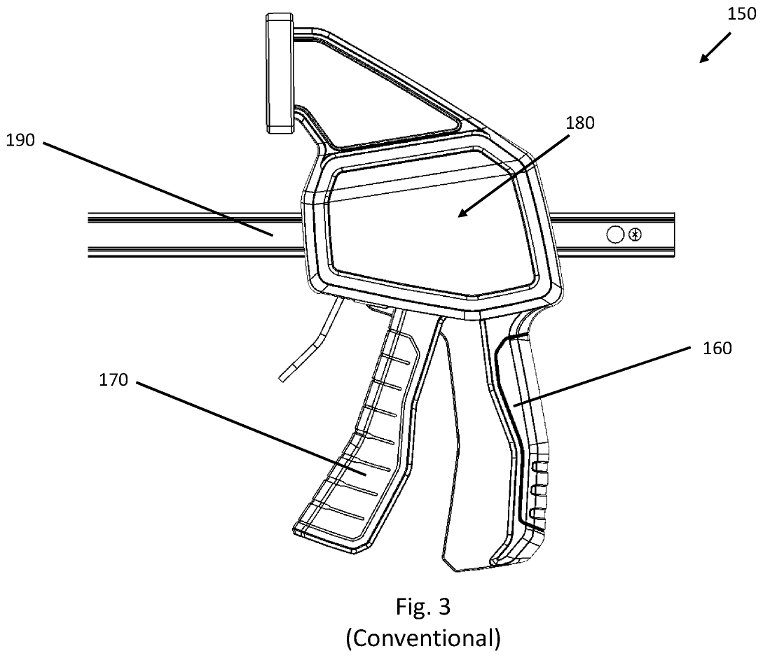

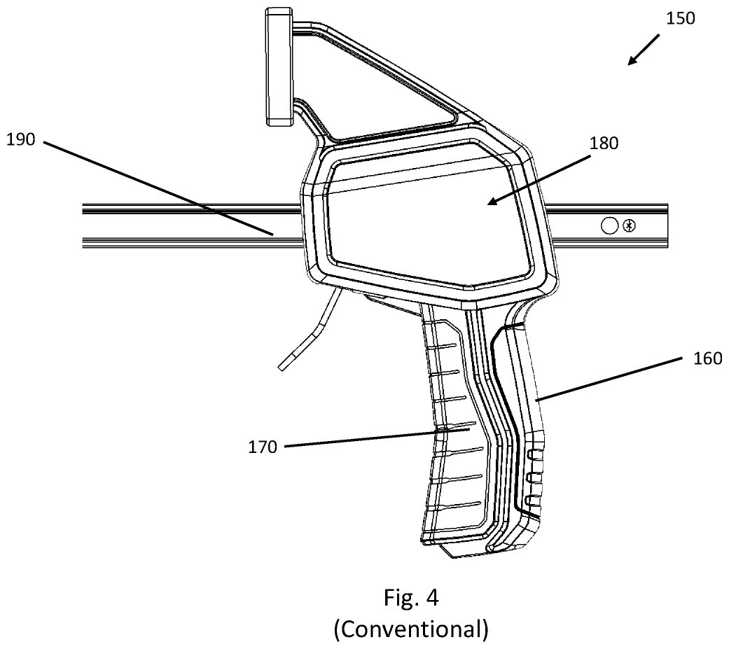

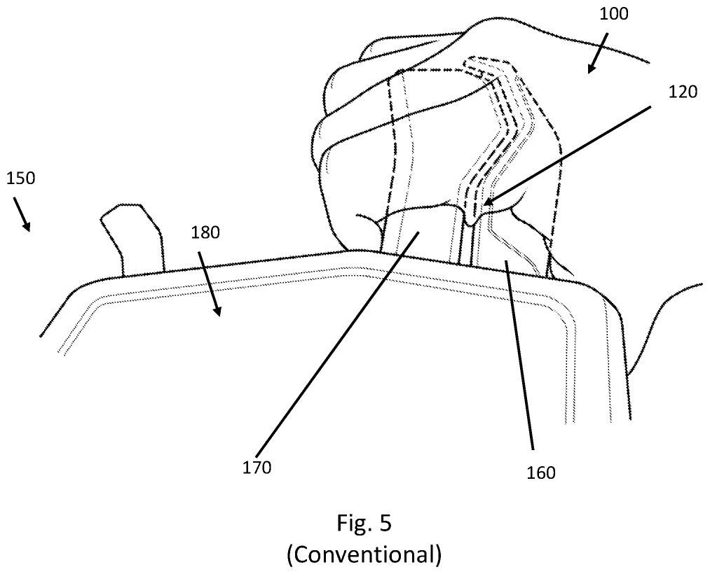

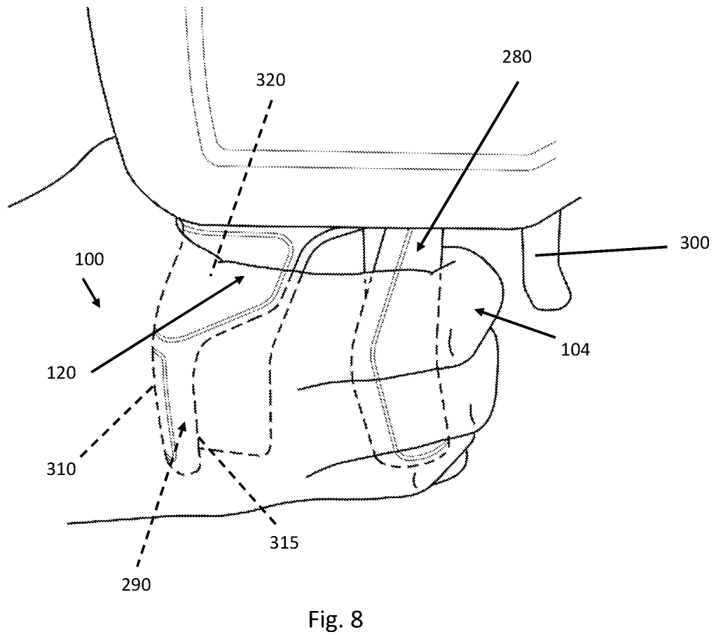

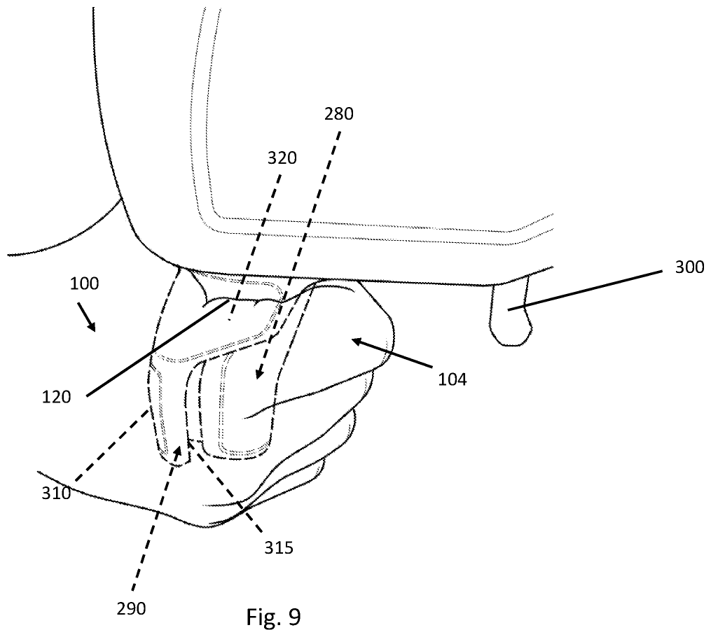

This configuration may be understood with reference to FIGS. 8 and 9. In particular, it may be appreciated (as compared to the conventional trigger clamp 150 of FIGS. 3 and 4), that as the trigger 280 is squeezed towards the handle 290, wrinkling of the fleshy pad 120 adjacent to the index finger 104 is protected from inadvertently coming between the trigger 280 and the handle 290 by the extension of the fin 320. In particular, to the extent any wrinkling of flesh on the index finger 104 occurs, it is outside the area where the trigger 280 is received behind the fin 320 of the handle 290.

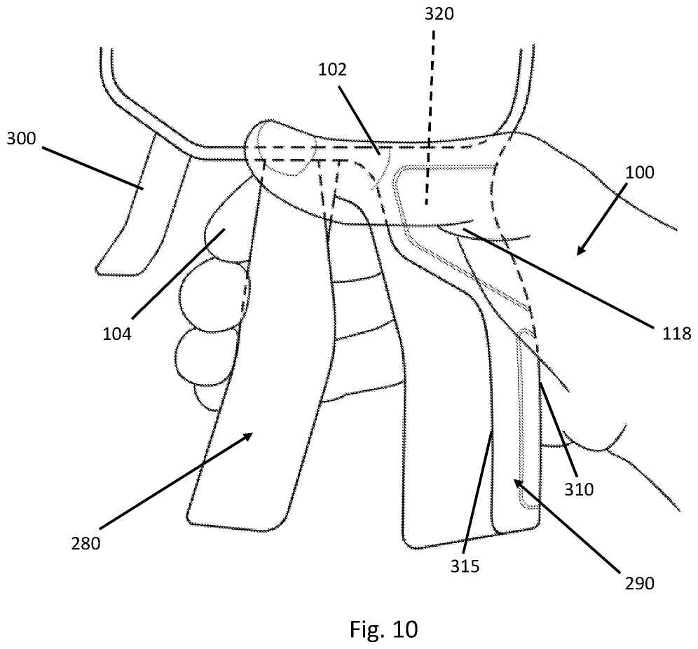

As shown in the illustrated embodiments, in some embodiments, the fin 320 may be duplicated on both the thumb side (e.g., left side for a right-handed user) and the index finger side (e.g., right side for a right-handed user) of the handle 290. It may be appreciated, with reference to FIG. 10, that the positioning of the fin 320 between the thumb 102 and the trigger 280, besides for providing a symmetry for left and right handed usage of the clamp 200, may also prevent the fleshy pad 118 adjacent to the thumb 102 from coming between the trigger 280 and the handle 290.

Regarding the protrusion of the fin 320, with reference returning to FIG. 6, the trigger facing wall 315 may therefore generally extend along a first plane A that intersects the handle 290, before extending towards the trigger 280 towards a second plane B defining an extension 325 of the fin 320. It may be appreciated that the trigger facing wall 315 may have an irregular or somewhat curved shape, and as such, the plane A and the plane B may be defined by a general location at a midpoint of a curved or multifaceted segment for the trigger facing wall 315 in some embodiments, or may be defined by the start of the appreciable divergence from generally perpendicular to the rail 210 at the plane A, and generally parallel to the rail 210 at the plane B. Regardless, the extension 325 may be sized based on a common length of an index finger 104, such that squeezing of the trigger 280 causes the pad 120 to wrinkle on top of the fin 320, rather than between the trigger facing wall 315 and the trigger 280. Accordingly, the extension 325 of the fin 320 may be defined as a distance between the plane A and the plane B. In some embodiments, the extension 325 may be greater than 5 mm in length, may be greater than 10 mm in length, may be greater than 15 mm in length, or may be greater than 20 mm in length, or may be greater than 25 mm in length, or may be greater than 30 mm in length. In an embodiment, the extension 325 may be approximately between 27 and 31 mm in length. In some embodiments, the extension 325 may be as much as 40 mm in length. In various embodiments, the extension 325 may be solid, or may have a webbed configuration with one or more openings formed therein. In such latter embodiments, the openings may be spaced or otherwise formed so as to prevent folds of the fleshy pads (e.g., fleshy pad 120) from entering therein and being exposed to an intersection of movement between the trigger 280 and the handle 290.

It may be appreciated that a height 327 of the fin 320 may be generally sized based on a thickness of a common index finger 104. As such, a region of the fin 320 where the index finger 104 normally engages may be defined between a plane C proximal to the rail member 210 and a plane D further from the rail member 210, where the intersection of the trigger facing wall 315 at the fin 320 at the plane C and plane D is closer to the plane B than the plane A. It may be appreciated that the plane C and the plane D may be generally parallel to the rail member 210 in some embodiments, where such generality may be defined by the contours of the handle 290 as configured to be engaged by the range of motion and common grasping angle of the hand 100, and in particular the index finger 104 of the user. In some embodiments, the height 327 may be greater than 15 mm in length. In an embodiment, the height 327 may be greater than 20 mm in length. In still other embodiments, a height 327 may be defined from where the trigger facing wall 315 extends generally non-perpendicular to the rail member 210 to where the handle 290 starts protruding from the movable jaw member 240 engaging the rail member 210, and may be approximately less than 40 mm.

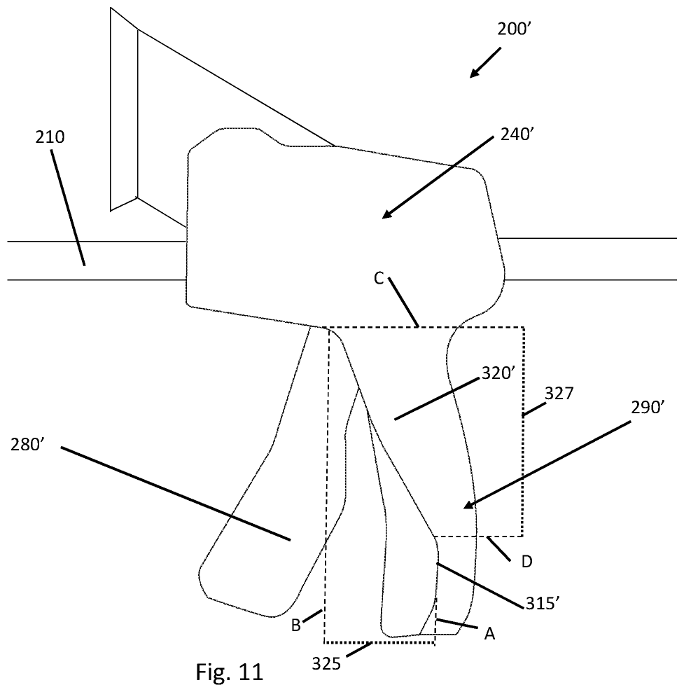

It may be appreciated that in other embodiments, the height 327 of the fin 320 may extend further away from the rail, such that the fin 320 is positioned so as to prevent a pinch point being formed between the handle 290 and trigger 280 at the middle finger 106, ring finger 108, and/or pinkie finger 110. Accordingly, in some embodiments the height 327 may be greater than approximately 40 mm, greater than approximately 60 mm, greater than approximately 80 mm, or greater than approximately 100 mm. As shown in FIG. 11, in an embodiment of a trigger clamp 200′ having an alternate movable jaw 240′ with a differing handle 290′, a height 327 of a fin the handle 290′ may be so configured, with a trigger facing wall 315′ that diverges from the plane A towards the plane B proximal to where a pinkie finger 110 may extend towards the trigger 280′.

As noted above, in some embodiments the handle 290 curves or otherwise extends from a backwall 310 towards the trigger 280. It may be appreciated that such a shape may match the contour of the curve of the hand 100 when engaging the handle 290 and trigger 280. As shown more clearly in the perspective view of FIGS. 12 and 13, in some embodiments additional structure to prevent a pinch point being formed between the handle 290 and trigger 280 may also or alternatively be formed in the movable jaw 240. For example, as shown in the illustrated embodiment, the backwall 310 may include protruding therefrom a flange 330 which may be configured to be selectively received within a receptacle 340 in the trigger 280 as the trigger 280 is pivoted towards the handle 290. In other embodiments, the handle 290 may be otherwise configured such that the flange 330 may selectively abut a surface 350 on the trigger 280. Accordingly, in some embodiments, the flange 330 may extend forward of the plane A for a longer distance than the receptacle 340 extends between a corresponding handle facing wall 355 to the abutting surface 350.

Such configurations may maintain a gap 360, as generally indicated in FIG. 13, between a portion of the trigger 280 and a portion of the backwall 310 below the fin 320 when the trigger 280 is squeezed close to the handle 290. It may be appreciated that in other embodiments, these configurations may be inverted, such that a protrusion on the trigger 280 may be configured to selectively abut a stop surface on the backwall 310, or other stop mechanism may be utilized to maintain the gap 360 below the fin 320 proximal to where it is engaged by the hypothenar eminence 116. As noted above, in trigger clamps where the trigger and the handle match in contour when the trigger is squeezed towards the handle (e.g., as shown, the trigger facing wall 315 and the handle facing wall 355 are generally matching in contour outside of where the trigger 280 is received under the fin 320), or where the trigger facing wall 315 surrounds a flange 330 that is received into the trigger 280 as the trigger 280 is squeezed towards the handle 290, such a gap may be of particular use to prevent a pinch point being formed therebetween while maintaining a greater compactified configuration of the trigger when squeezed (e.g., as compared to other clamps where the trigger and the handle remain divergent from one another in shape even when squeezed).

While the gap 360 maintained between the of the trigger facing wall 315 (e.g., that region below the fin 320) and corresponding region of the handle 290 may vary across embodiments, in some embodiments the gap 360 may be approximately 5-25 mm in length, sufficient to prevent folds of the fleshy pads below the index finger 104 (e.g. fleshy pads 122, 124 or 126) from being pinched between the trigger facing wall 315 and the trigger 280. In the nonlimiting illustrated embodiment, the gap 360 is approximately 8 mm in length. In other embodiments, the gap 360 may be greater than approximately 3 mm. In some embodiments, the gap 360 may be as great as approximately 20 mm, or may be as great as approximately 30 mm, or may be as great as approximately 40 mm, or may be as great as approximately 50 mm (such gap 360 being understood as limiting a maximum amount of compression of the trigger 280 towards the handle 290).

In various embodiments, the clamps and components thereof described herein may be formed of metal, plastic, ceramic, or any other appropriate material. It may be appreciated that the components described herein may be of different constructions or configurations, including but not limited to one or more being comprised of different material choices. For example, the components described herein may each be constructed from a variety of materials, including but not limited to one or more of fabrics, plastics, metals, rubbers, elastomers, or any other appropriate material choice. For example, in an embodiment one or more of the components (e.g., the rail member 210) may be formed of aluminum (e.g., machined aluminum), iron (e.g., steel), or any other appropriate material. Similarly, portions of the clamp 200, including one or more the fixed jaw 230, the movable jaw 240 and sub components thereof may be formed from molded plastic, metal, or combinations thereof (e.g., plastic with metal supports or fasteners coupling portions tougher). In some embodiments, structural and functional components may be formed from metal or hard plastic, while gripped components positioned to engage the palm of a gripping hand to provide the palm with a comfortable gripping surface may be made of a suitable molded plastic material or elastomeric material, and may be generally formed as a bi-material suitable molded plastic material coated with a layer of an elastomeric material, such as a rubber based material. In some embodiments, the material choices may differ from component to component. In various embodiments, some components may be integrally formed together, while other components may be assembled by any appropriate mechanism, including but not limited to fastened, welded, snap-fit, friction fit, adhesive bonding, or other appropriate securements.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A trigger clamp comprising:
a rail;
a movable jaw configured to move along the rail;
a handle fixed relative to the movable jaw; and
a trigger movable relative to the handle, which when pulled towards the handle causes movement of the movable jaw along the rail;
wherein the handle comprises a trigger facing wall generally extending along a first plane, and a fin generally extending to a second plane, the second plane being closer to the trigger than the first plane;
wherein the trigger is shaped to be received to an interior of the fin at least when the trigger is squeezed by a hand of a user, such that an index finger of the user remains at the exterior of the fin.

2. The trigger clamp of claim 1, wherein the trigger is positioned forward of the fin until pulled towards the fin by the hand of the user.

3. The trigger clamp of claim 1, wherein the handle comprises a backwall that extends towards the trigger to define the trigger facing wall.

4. The trigger clamp of claim 3, wherein the backwall curves towards the trigger facing wall.

5. The trigger clamp of claim 1, wherein an extension of the fin between the first plane and the second plane is approximately 5-40 mm.

6. The trigger clamp of claim 5, wherein the extension of the fin is approximately 30 mm.

7. The trigger clamp of claim 1, wherein the trigger comprises a handle facing wall that generally matches a contour of the trigger facing wall away from the fin.

8. The trigger clamp of claim 7, wherein the trigger and the handle are configured to maintain a gap between the trigger facing wall and the handle facing wall away from the fin.

9. The trigger clamp of claim 8, wherein the handle comprises a flange that extends from the handle towards the trigger further than the trigger facing wall.

10. The trigger clamp of claim 9, wherein the flange is received in the trigger when the trigger is squeezed by the user.

11. The trigger clamp of claim 8, wherein the gap is greater than approximately 3 mm.

12. The trigger clamp of claim 7, wherein from a side profile of the clamp and away from the fin, a backwall of the handle, the trigger facing wall of the handle, and the handle facing wall of the trigger have matching contours.

13. The trigger clamp of claim 1, wherein a height of the fin is defined between a third plane and a fourth plane, the third plane and the fourth plane being generally parallel to the rail member, and generally perpendicular to the first plane.

14. The trigger clamp of claim 13, wherein the extension of the fin is approximately 15-40 mm.

15. The trigger clamp of claim 14, wherein the extension of the fin is approximately 20 mm.

16. A method of manufacturing a trigger clamp comprising:
providing a rail;
forming a movable jaw configured to move along the rail, with a handle fixed relative to the movable jaw; and
providing a trigger movable relative to the handle, which when pulled towards the handle causes movement of the movable jaw along the rail;
wherein the handle comprises a trigger facing wall generally extending along a first plane, and a fin generally extending to a second plane, the second plane being closer to the trigger than the first plane;
wherein the trigger is shaped to be received to an interior of the fin at least when the trigger is squeezed by a hand of a user, such that an index finger of the user remains at the exterior of the fin.

17. The method of claim 16, wherein a contour of the trigger facing wall matches a contour of a handle facing wall formed on the trigger.

18. A method of operating a trigger clamp, wherein the trigger clamp comprises
a rail
a movable jaw configured to move along the rail;
a handle fixed relative to the movable jaw; and
a trigger movable relative to the handle, which when pulled towards the handle causes movement of the movable jaw along the rail;
wherein the handle comprises a trigger facing wall generally extending along a first plane, and a fin generally extending to a second plane, the second plane being closer to the trigger than the first plane; and
wherein the trigger is shaped to be selectively received to an interior of the fin the method comprising:
engaging, by a hand of a user, the handle and the trigger of the trigger clamp, such that a palm of the user wraps around a backwall of the handle distal from the trigger, and at least an index finger of the user extends over the fin to the trigger; and
pulling the trigger towards the handle with at least the index finger, such that the index finger of the user remains at the exterior of the fin while the trigger is in or moves into an interior of the fin.

19. The method of claim 18, wherein a contour of the trigger facing wall matches a contour of a handle facing wall formed on the trigger.
